(19) United States
(12) Patent Application Publication
(10) Pub. No.: US 2017/0256160 A1
(43) Pub. Date: Sep. 7, 2017

(54) METHOD AND DEVICE FOR SWITCHING AN OPERATING MODE OF A REMOTE CONTROLLER

(71) Applicants: Le Holdings(Beijing)Co., Ltd., Beijing (CN); LE SHI ZHI XIN ELECTRONIC TECHNOLOGY (TIAN JIN) LIMITED, Tianjin (CN)

(72) Inventors: Haipeng Zhang, Tianjin (CN); Fei Yao, Tianjin (CN)

(21) Appl. No.: 15/244,778

(22) Filed: Aug. 23, 2016

Related U.S. Application Data
(63) Continuation of application No. PCT/CN2016/088966, filed on Jul. 6, 2016.

(30) Foreign Application Priority Data
Mar. 2, 2016 (CN) 201610118302.8

(51) Int. Cl. G08C 17/02; G08C 23/04

(52) U.S. Cl. CPC G08C 17/02; G08C 23/04; H04N 2005/4414

(57) ABSTRACT

The disclosure provides a method and device for switching an operating mode of a remote controller so as to address the problem in the prior art of inconvenient operations of switching the mode of the remote controller to thereby improve the experience of a user. The method for switching an operating mode of a remote controller includes: receiving a first pairing instruction transmitted by a first remote controller in an infrared mode, wherein the first pairing instruction carries the first device identifier of the first remote controller; searching a list of stored device identifiers to determine whether the first device identifier is present in the list; if so, then performing a pairing flow, and the remote controller is switched to the radio mode after a successful paring; otherwise, rejecting the first pairing instruction.

### CROSS REFERENCE TO RELATED APPLICATIONS

This application is a continuation of International Application No. PCT/CN2016/088966, filed on Jul. 6, 2016, which is based upon and claims priority to Chinese Patent Application No. 201610118302.8, filed on Mar. 2, 2016, the entire contents of which are incorporated herein by reference.

### TECHNICAL FIELD

The present disclosure relates to the field of remote controller technologies, and particularly to a method and device for switching an operating mode of a remote controller.

### BACKGROUND

A TV set has become an indispensable digital product at home, since a user needs to keep some distance away from the TV set when the user watches TV, only a few buttons are arranged on the TV set, and instead the TV set is controlled using a remote controller. Remote control refers to one of long-range controlling technologies, and a device configured to control a mechanism remotely is referred to as a remote controller. The existing remote controller is provided with both a variety of functions and a number of remote control modes to provide the user with a better experience of the TV set.

In the traditional field of TV remote controllers, the TV set is generally controlled using an infrared remote controller configured to transmit a control signal using near infrared rays. The infrared rays are converted into a digital signal which can be recognized by a receiver in the TV set so that the remote controller can remotely control the TV set at a long distance. However the infrared remote controller can not remotely control the TV set across an obstacle or at a wide angle due to the constraint of the infrared rays.

In order to address the drawback of the infrared remote controller above, a radio emote controller has emerged in response thereto. The radio remote controller is configured to transmit a remote control signal over a radio wave in the frequency band ranging from 2.405 GHz to 2.485 GHz to thereby remotely control the TV set at respective angles. The radio remote controller can provide some control functions to which the infrared remote controller is inaccessible, e.g., an air mouse function, a voice function, etc. However the radio remote controller is susceptible to interference from another device, e.g., a household microwave oven operating at 2.4 GHz, a WiFi network operating in the same frequency band, a cordless telephone, etc., where the operating power of the device is so high that communication between the radio remote controller and the TV set may be affected and even fails, thus degrading the precision of a remote control operation.

Accordingly the two operating modes above are generally accessible in the existing remote controllers so that the user is allowed to switch between the two modes in different use environments. The inventors have identified that in the prior art, if the user needs to access the radio remote controller, then he or she will open a battery chamber on the back of the remote controller, and press a pairing button therein to pair the TV set with the remote controller to thereby enter the radio remote controller mode; after pairing of the remote controller with the TV set is disabled, the remote controller operates in the infrared mode; and if the radio remote controller needs to be accessed again, then the user will open again the battery chamber on the back of the remote controller, and press the pairing button therein to control the TV set to be paired with the remote controller to thereby enter the radio remote controller mode. Apparently in the prior art, the remote controller mode has to be switched in so troublesome operations that it may not be convenient for the user to access.

### SUMMARY

The disclosure provides a method and device for switching an operating mode of a remote controller so as to address the problem in the prior art of inconvenient operations of switching the mode of the remote controller to thereby improve the experience of a user.

An embodiment of the disclosure provides a method, performed by an electronic device, for switching an operating mode of a remote controller, the method including:
receiving a first pairing instruction transmitted by a first remote controller in an infrared mode, wherein the first pairing instruction carries the first device identifier of the first remote controller; and
if the first device identifier is present in a list of stored device identifiers, then performing a pairing flow;
otherwise, rejecting the first pairing instruction.

An embodiment of the disclosure provides a method, performed by a remote controller, for switching an operating mode of the remote controller, the method including:
if the remote controller operates in an infrared mode, then transmitting a first pairing instruction to an electronic device upon detecting an event to trigger the remote controller to be switched to a radio mode, wherein the first pairing instruction carries the device identifier of the remote controller; and
switching the remote controller to the radio mode after the remote controller is paired successfully with the electronic device.

An embodiment of the disclosure provides an electronic device including:
at least one processor; and
a memory communicably connected with the at least one processor for storing instructions executable by the at least one processor, wherein execution of the instructions by the at least one processor causes the at least one processor to:
receive a first pairing instruction transmitted by a first remote controller in an infrared mode, wherein the first pairing instruction carries the first device identifier of the first remote controller;
search a list of stored device identifiers to determine whether the first device identifier is present in the list; and
perform a pairing flow if the searching unit locates the first device identifier; and reject the first pairing instruction if the searching unit does not locate the first device identifier.

With the method, system, and related device for switching an operating mode of a remote controller according to the embodiments of the disclosure, the remote controller operating in the infrared mode transmits the pairing instruction carrying the device identifier thereof to the electronic device upon detecting the event to trigger pairing, and the electronic devices determines whether to accept the pairing instruction of the remote controller, by searching the list of device identifiers stored by the electronic device. In the process above, the electronic device can be automatically paired with the remote controller without opening the battery compartment on the back of the remote controller and pressing the pairing button by the user, to thereby simplify the operations of pairing the electronic device with the remote controller so as to improve the experience of the user.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1A is a schematic flow chart of an implementation of a method, performed by an electronic device, for switching an operating mode of a remote controller according to an embodiment of the disclosure;

FIG. 1B is a schematic diagram of a first UI interface for switching from a radio mode to an infrared mode according to an embodiment of the disclosure;

FIG. 1C is a schematic diagram of a second UI interface for switching from a radio mode to an infrared mode according to an embodiment of the disclosure;

FIG. 2 is a schematic flow chart of an implementation of a method, performed by a remote controller, for switching an operating mode of the remote controller according to an embodiment of the disclosure;

FIG. 3 is a schematic structural diagram of an electronic device according to an embodiment of the disclosure;

FIG. 4 is a schematic structural diagram of a remote controller according to an embodiment of the disclosure; and

FIG. 5 is a schematic structural diagram of a system for switching an operating mode of a remote controller according to an embodiment of the disclosure.

### DETAILED DESCRIPTION

In order to make the objects, technical solutions, and advantages of the embodiments of the disclosure more apparent, the technical solutions according to the embodiments of the disclosure will be described below clearly and fully with reference to the drawings in the embodiments of the disclosure, and apparently the embodiments described below are only a part but not all of the embodiments of the disclosure. Based upon the embodiments here of the disclosure, all the other embodiments which can occur to those skilled in the art without any inventive effort shall fall into the scope of the disclosure.

The inventors have identified that the existing remote controller may be switched between the infrared mode and the radio mode in so inconvenient operations that result in a poor experience of the user. In view of this, an embodiment of the disclosure provides a method for switching an operating mode of a remote controller. A general principle of the disclosure is as follows: before the remote controller operates in the radio mode, it has to be paired with the electronic device so that the paired remote controller can operate in the radio mode; while no additional operations are needed for the infrared mode, so that the remote controller which does not operate in the radio mode can be switched automatically to the infrared mode. Hereupon a flow in which the remote controller is switched from the infrared mode to the radio mode will be focused on in the description the embodiment of the disclosure. Particularly if the remote controller is paired with the electronic device for the first time, then the user will press the pairing button arranged in the battery compartment on the back of the remote controller, and after they are paired successfully, the electronic device will store the device identifier of the successfully paired remote controller. If they are not paired for the first time, then some special function button in the remote controller in the radio mode, e.g., an air mouse button, a voice button, etc., can be pressed to trigger the flow in which the remote controller is paired automatically with the electronic device, where the electronic device determines whether the remote controller is paired for the first time by identifying the device identifier of the remote controller requesting for being paired, and if so, then the device identifier of the remote controller requesting for being paired will be absent in a list of device identifiers stored by the electronic device; otherwise, the device identifier of the remote controller requesting for being paired will be stored in the list of device identifiers; and if the electronic device locates the device identifier of the remote controller requesting for being paired, in the list of device identifiers stored by the electronic device, then the electronic device will perform the pairing flow without pressing again the pairing button arranged in the remote controller. A flow of an implementation of the method for switching an operating mode of a remote controller according to the embodiment of the disclosure will be described below in connection with particular embodiments thereof.

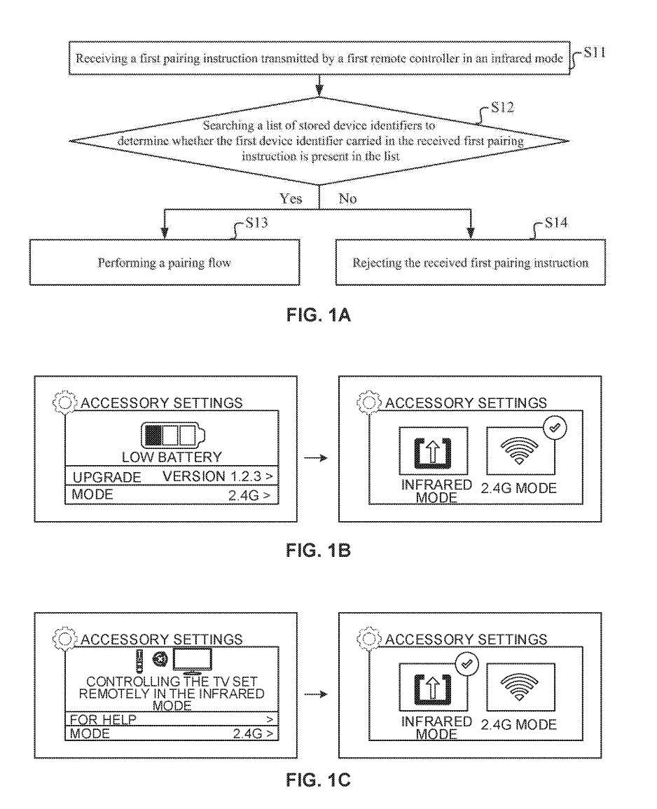

As illustrated in FIG. 1A, there is a schematic flow chart of an implementation of a method, performed by an electronic device, for switching an operating mode of a remote controller according to an embodiment of the disclosure, where the method can include the following operations:

S11. Receiving a first pairing instruction transmitted by a first remote controller in an infrared mode.

For a design of the remote controller, some function buttons unnecessary in a radio mode may be accessed in the infrared mode, e.g., Up, Down, Left, and Right direction buttons, a confirmation button, a menu button, etc., so before the electronic device is paired with the remote controller, the remote controller operates in the infrared mode to control the electronic device to operate.

If a user needs to access some special function buttons in the radio mode, e.g., an air mouse function and a voice function, or the user needs to access the radio mode, for example, the user needs to switch the remote controller to the radio mode when there is a large angle between the user and the electronic device, the infrared mode is not sensitive, etc., then the user can press some special function buttons, arranged on the remote controller, accessible only in the radio mode, e.g., an air mouse button or a voice button, to trigger the first remote controller to transmit the first pairing instruction to the electronic device. It shall be noted that before they are paired, the remote controller still operates in the infrared mode, so the remote controller needs to transmit the first pairing instruction via infrared to the electronic device by carrying the device identifier of the remote controller in the first pairing instruction.

S12. Searching a list of stored device identifiers to determine whether the first device identifier carried in the received first pairing instruction is present in the list, and if so, then the flow will proceed to the operation S13; otherwise, the flow will proceed to the operation S14.

In a particular implementation, upon reception of the first pairing instruction, the electronic device searches the list of device identifiers stored by the electronic device to determine whether the first device identifier is present in the list, according to the first device identifier of the first remote controller requesting for being paired, carried in the received first pairing instruction.

Here the list of device identifiers is created by the electronic device as follows: after being paired successfully with the remote controller for the first time, the electronic device stores locally the device identifier of the successfully paired remote controller.

If the first remote controller is paired with the electronic device for the first time, then the first device identifier of the first remote controller will be absent in the list of device identifiers; and if the first remote controller is not paired with the electronic device for the first time, then the first device identifier of the first remote controller will be present in the list of device identifiers.

S13. Performing a pairing flow, and then the flow ends.

Particularly the electronic device receives a pairing key transmitted by the first remote controller, verifies the received pairing key, and if the verification is passed, then it is determined that the pairing is successful; otherwise, it is determined that the pairing is unsuccessful. In a particular implementation, the electronic device rejects the received first pairing instruction upon failing to perform the pairing flow.

S14. Rejecting the received first pairing instruction.

Preferably after the operation S14 is performed, the user can be further notified to perform pairing using a physical button on the first remote controller. That is, if the electronic device does not locate the first device identifier of the first remote controller in the list of stored device identifiers, then this will indicate that the first remote controller is paired with the electronic device for the first time, and needs to be paired using the pairing button arranged in the first remote controller.

After the first remote controller is paired successfully with the electronic device, the electronic device transmits a pairing success message to the first remote controller, and the first remote controller is switched to the radio mode upon determining from the received message that they are paired successfully, so that the user can access some special function buttons in the radio mode, e.g., an air mouse function button or a voice function button.

If the user needs to disable pairing of the first remote controller with the electronic device, then perform the followings:

Operation 1. Receiving a pairing disabling message transmitted by the first remote controller in the radio mode, where the pairing disabling message carries the first device identifier of the first remote controller.

In a particular implementation, the user can press for a long period of time some special function button accessible only in the radio mode, e.g., a voice button or an air mouse button, to trigger the first remote controller to transmit a broadcast message of disable pairing to the electronic device, and the paired electronic device starts an underlying command upon reception of the broadcast message of disable pairing, to disable the first remote controller paired with the electronic device, so that the first remote controller is not paired. After pairing is disabled, the electronic device further notifies the user (e.g., via a Toast message box) that the first remote controller has been disabled from being paired, where Toast is a popup message in the Android system.

Operation 2. Disabling pairing with the first remote controller according to the first device identifier carried in the pairing disabling message.

In a particular implementation, if the remote controller operates in the radio mode (i.e., the 2.4G mode), then the infrared mode can be selected directly in a User Interface (UI) available from the electronic device; but not vice versa. This is because that the remote controller can be switched from the radio mode to the infrared mode simply by disabling pairing of the remote controller with the electronic device, and this flow can be performed at the electronic device side, so that the remote controller will operate in the infrared mode, and if switching from the radio mode to the infrared mode is selected in the UI, then the electronic device will simply invoke an underlying instruction. If the remote controller is switched from the infrared mode to the radio mode, then the remote controller shall be paired, and the pairing instruction of the remote controller can only be transmitted by the remote controller; and since the remote controller can only perform transmitting but can not receiving, if the user is operating on the UI at the remote controller, a pairing signal can not be transmitted to the remote controller, and the pairing instruction can not be transmitted by the remote controller either. As illustrated in FIG. 1B and FIG. 1C, there are schematic diagrams of the UI interfaces for switching from the radio mode to the infrared mode.

In a particular implementation, such an application scenario may also occur that the user possesses a number of remote controllers, where one of the remote controllers being paired with the electronic device is the first remote controller, for example, and if the user needs to pair another remote controller (referred to as a second remote controller in an embodiment of the disclosure) with the electronic device to thereby control the electronic device to operate, using the second remote controller, then the flow will further include the following operations after the first remote controller is paired successfully with the electronic device in an embodiment of the disclosure:

The electronic device receives a second pairing instruction transmitted by a second remote controller in the infrared mode, where the second pairing instruction carries the second device identifier of the second remote controller, and disables pairing with the first remote controller upon determining from the second device identifier that the electronic device is paired successfully with the second remote controller.

Particularly the electronic device is paired with the second remote controller in accordance with the operation S12 to the operation S14 upon reception of the second pairing instruction transmitted by the second remote controller, where the electronic device firstly searches the list of device identifies stored by the electronic device to determine whether the second device identifier is present in the list, and if so, then the electronic device will perform a pairing verification process particularly as described for the process in which the electronic device and the first remote controller are verified for pairing, so a repeated description thereof will be omitted here. If they are verified successfully for pairing, then it is determined that the electronic device is paired successfully with the second remote controller; otherwise, the second pairing instruction transmitted by the second remote controller is rejected, that is, the electronic device is paired unsuccessfully with the second remote controller. If the second device identifier is absent in the list of device identifiers stored by the electronic device, then the electronic device will reject the pairing instruction transmitted by the second remote controller, that is, the electronic device is paired unsuccessfully with the second remote controller, and instruct the user to pair using a physical pairing button on the second remote controller.

It shall be noted that one electronic device can not be paired with a number of remote controllers at the same time, so the electronic device needs to disable pairing with the first remote controller, upon determining that the electronic device is paired successfully with the second remote controller, and preferably the electronic device can further notify the user that pairing with the first remote controller has been disabled, for example, the electronic device notifies the user in a Toast message that the electronic device is paired successfully with the second remote controller, and pairing with the first remote controller is disabled, upon determining that the electronic device is paired successfully with the first remote controller.

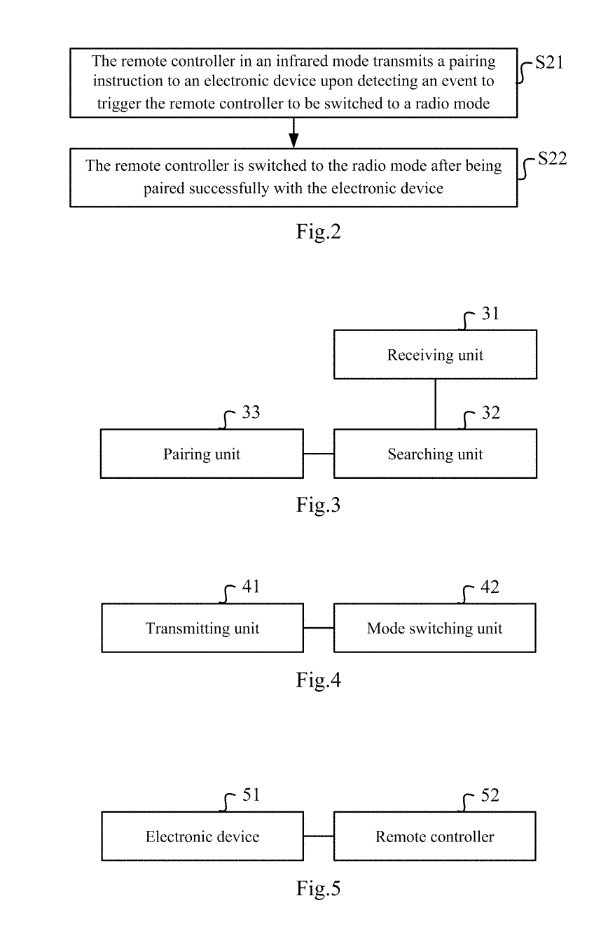

Correspondingly an embodiment of the disclosure provides a method, performed by a remote controller, for switching an operating mode of the remote controller as illustrated in FIG. 2, where the method can include the following operations:

S21. The remote controller in an infrared mode transmits a pairing instruction to an electronic device upon detecting an event to trigger the remote controller to be switched to a radio mode.

In a particular implementation, the event to trigger the remote controller to be switched to the radio mode can be that a corresponding button being triggered is detected, for example, if it is detected a special function button available only in the radio mode (e.g., an air mouse button or a voice button), then it can be determined that an event to trigger the remote controller to be switched to the radio mode is detected. If it is determined that the event to trigger the remote controller to be switched to the radio mode is detected, then the remote controller will transmit via infrared the pairing instruction carrying the device identifier of the remote controller to the electronic device.

S22. The remote controller is switched to the radio mode after being paired successfully with the electronic device.

In a particular implementation, the electronic device performs a flow of pairing with the remote controller in accordance with the operation S11 to the operation S14, and if they are paired successfully, then the remote controller will be switched to the radio mode.

In a particular implementation, the remote controller can determine that the remote controller is paired successfully with the electronic device, upon reception of a pairing success message transmitted by the electronic device.

In a particular implementation, the method, performed by the remote controller, for switching an operating mode of the remote controller can further include the operation of transmitting by the remote controller in the radio mode a pairing disabling message carrying the device identifier of the remote controller to the electronic device upon detecting of an event to trigger pairing to be disabled.

In a particular implementation, the event to trigger pairing to be disabled can be that a corresponding button being triggered is detected, for example, if it is detected that the user is pressing for a long period of time a special function button available only in the radio mode (e.g., an air mouse button or a voice button), then it will be determined that an event to trigger pairing to be disabled is detected. If it is determined that the event to trigger pairing to be disabled is detected, then the remote controller will transmit a pairing disabling broadcast message carrying the device identifier of the remote controller to the electronic device. The paired electronic device disables pairing with the remote controller in response to the received pairing disabling broadcast message.

With the method for switching an operating mode of a remote controller according to the embodiment of the disclosure, the remote controller operating in the infrared mode transmits the pairing instruction carrying the device identifier thereof to the electronic device upon detecting an event to trigger pairing, and the electronic device searches the list of device identifiers stored by the electronic device; and if the device identifier is present in the list of device identifiers, then the electronic device will be verified with the remote controller for paring, and if the verification is passed, then the electronic device will determine that they are paired successfully; or if the device identifier is absent in the list of device identifiers, then the remote controller will prompt the user to open the battery compartment on the back of the remote controller, and to pair them using the physical pairing button. In the process above, the electronic device can automatically pair with the remote controller without opening the battery compartment on the back of the remote controller, and pressing the pairing button by the user, to thereby simplify the operations of pairing the electronic device with the remote controller so as to improve the experience of the user.

The electronic device as referred to in the embodiments of the disclosure can be but will not be limited to a TV set, but can be any electronic device to be paired with a remote controller, e.g., an air conditioner, etc.

Based upon the same inventive idea, embodiments of the disclosure further provide an electronic device, a remote controller, and a system for switching an operating mode of a remote controller, and since the device and the system address the problem under a similar principle to the methods above for switching an operating mode of a remote controller, reference can be made to the implementations of the methods for implementations thereof, so a repeated description thereof will be omitted here.

As illustrated in FIG. 3, there is a schematic structural diagram of an electronic device according to an embodiment of the disclosure, where the electronic device can include:

A receiving unit 31 configured to receive a first pairing instruction transmitted by a first remote controller in an infrared mode, where the first pairing instruction carries the first device identifier of the first remote controller;

A searching unit 32 configured to search a list of stored device identifiers to determine whether the first device identifier is present in the list; and

A pairing unit 33 configured to perform a pairing flow if the searching unit 32 locates the first device identifier; and to reject the first pairing instruction if the searching unit 32 does not locate the first device identifier.

In a particular implementation, the electronic device according to the embodiment of the disclosure can further include:

A first notifying unit configured to notify a user to perform pairing using a physical button on the remote controller after the pairing unit 33 rejects the first pairing instruction.

Preferably the pairing unit 33 can include:

A receiving sub-unit configured to receive a pairing key transmitted by the first remote controller;

A verifying sub-unit configured to verify the pairing key; and

A pairing sub-unit configured to determine that the paring is successful when the verification by the verifying sub-unit of the pairing key is passed; and to determine that the paring is unsuccessful when the verification by the verifying sub-unit of the pairing key is not passed.

Optionally the receiving unit 31 can be further configured to receive a second pairing instruction transmitted by a second remote controller in the infrared mode, where the second pairing instruction carries the second device identifier of the second remote controller; and

The pairing unit 33 can be further configured to disable pairing with the first remote controller upon determining from the second device identifier that the electronic device is paired successfully with the second remote controller.

Optionally the receiving unit 31 can be further configured to receive a pairing disabling message transmitted by the first remote controller in the radio mode, where the pairing disabling message carries the first device identifier of the first remote controller; and

The pairing unit 33 can be further configured to disable pairing with the first remote controller according to the first device identifier carried in the pairing disabling message.

Optionally the electronic device according to the embodiment of the disclosure can further include:

A second notifying unit configured to notify a user that the first remote controller has been disabled from being paired, after the pairing unit disables pairing with the first remote controller.

As illustrated in FIG. 4, there is a schematic structural diagram of a remote controller according to an embodiment of the disclosure, where the remote controller can include:

A transmitting unit 41 configured, if the remote controller operates in an infrared mode, to transmit a pairing instruction to an electronic device upon detecting an event to trigger the remote controller to be switched to a radio mode, where the pairing instruction carries the device identifier of the remote controller; and

A mode switching unit 42 configured to switch the remote controller to the radio mode after the remote controller is paired successfully with the electronic device.

Here the transmitting unit 41 can be further configured, if the remote controller operates in the radio mode, to transmit a pairing disabling message carrying the device identifier of the remote controller to the electronic device upon detecting of an event to trigger pairing to be disabled.

For the sake of a convenient description, the respective components above have been described respectively as the respective modules (or units) according to the functions thereof. Of course, in an implementation of the disclosure, the functions of the respective modules (or units) can be performed in the same one or more pieces of software or hardware.

Further to the description of the method and apparatus for switching an operating mode of a remote controller according to the embodiments of the disclosure, an apparatus for switching an operating mode of a remote controller according to another embodiment of the disclosure will be described below.

In some possible embodiments, an apparatus for switching an operating mode of a remote controller according to an embodiment of the disclosure can include at least one processor and at least one memory, where the memory is configured to store program codes configured, upon being executed by the processor, to cause the processor to perform the respective operations in the method switching an operating mode of a remote controller according to the respective embodiments of the disclosure. For example, the processor can perform the operation S11 as illustrated in FIG. 1A of searching the list of stored device identifiers to determine whether the first device identifier carried in the received first pairing instruction is present in the list, and if so, then the processor will perform the operation S13 of performing a pairing flow; otherwise, the processor will perform the operation S14 of rejecting the received first pairing instruction.

An embodiment of the disclosure further provides a computer readable recording medium in which program for performing the method for switching an operating mode of a remote controller is recorded.

In some possible embodiments, an apparatus for switching an operating mode of a remote controller according to an embodiment of the disclosure can include at least one processor and at least one memory, where the memory is configured to store program codes configured, upon being executed by the processor, to cause the processor to perform the respective operations in the method switching an operating mode of a remote controller according to the respective embodiments of the disclosure. For example, the processor can be perform the operation S21 as illustrated in FIG. 2 of transmitting, the remote controller in an infrared mode, the pairing instruction to the electronic device upon detecting the event to trigger the remote controller to be switched to the radio mode, and the operation S22 of switching the remote controller to the radio mode after the remote controller is paired successfully with the electronic device.

An embodiment of the disclosure further provides a computer readable recording medium in which program for performing a data transmitting method is recorded.

As illustrated in FIG. 5, there is system for switching an operating mode of a remote controller according to an embodiment of the disclosure, where the system includes the electronic device 51 illustrated in FIG. 3, and the remote controller 52 illustrated in FIG. 4.

The related functional units illustrated in FIG. 3 can be embodied by a hardware processor in an embodiment of the disclosure. In a particular implementation, the processor can be configured to read the program in the memory, and to operate as the related functional units illustrated in FIG. 3 by performing the process of: receiving a first pairing instruction transmitted by a first remote controller in an infrared mode, where the first pairing instruction carries the first device identifier of the first remote controller; searching a list of stored device identifiers to determine whether the first device identifier is present in the list; and if so, then performing a pairing flow, and switching the first remote controller to the radio mode after they are paired successfully; otherwise, rejecting the first pairing instruction.

The related functional units illustrated in FIG. 4 can be embodied by a hardware processor in an embodiment of the disclosure. In a particular implementation, the processor can be configured to read the program in the memory, and to operate as the related functional units illustrated in FIG. 4 by performing the process of: in an infrared mode, transmit a first pairing instruction to an electronic device upon detecting an event to trigger the remote controller to be switched to a radio mode, where the first pairing instruction carries the device identifier of the remote controller; and switching the remote controller to the radio mode after the remote controller is paired successfully with the electronic device.

The embodiments of the apparatus described above are merely exemplary, where the units described as separate components may or may not be physically separate, and the components illustrated as elements for displaying may or may not be physical units, that is, they can be collocated or can be distributed onto a number of network elements. A part or all of the modules can be selected as needed in reality for the purpose of the solution according to the embodiments of the disclosure. This can be understood and practiced by those ordinarily skilled in the art without any inventive effort.

Those skilled in the art can appreciate that the respective embodiments described above can be performed by software combined with universal hardware platform, of course they can also be performed by hardware. In this case, the technical solution above in nature or a part of the technical solution that contributed to the existing technology can be embodied in the form of a software product, where the software product, including a number of instructions to enable a computer equipment (including a personal computer, a server, or a network equipment, etc.) to perform the methods in the respective embodiments or in a part of the respective embodiments, can be stored in a computer readable storage medium, for example a ROM/RAM, a magnetic disc, an optical disk, etc.

Lastly it shall be noted that the respective embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the spirit and scope of the disclosure as claimed.

What is claimed is:

1. A method for switching an operating mode of a remote controller, the method comprising:
receiving a first pairing instruction transmitted by a first remote controller in an infrared mode, wherein the first pairing instruction carries a first device identifier of the first remote controller; and
if the first device identifier is present in a list of stored device identifiers, then performing a pairing flow;
otherwise, rejecting the first pairing instruction.

2. The method according to claim 1, wherein after rejecting the first pairing instruction, the method further comprises:
notifying a user to perform pairing using a physical button on the remote controller.

3. The method according to claim 1, wherein performing the pairing flow comprises:
receiving a pairing key transmitted by the first remote controller;
verifying the pairing key; and
if the verification is passed, then determining that the paring is successful;
otherwise, determining that the paring is unsuccessful.

4. The method according to claim 3, wherein after the paring is successful, the method further comprises:
receiving a second pairing instruction transmitted by a second remote controller in the infrared mode, wherein the second pairing instruction carries a second device identifier of the second remote controller; and
disabling pairing with the first remote controller upon determining from the second device identifier that the electronic device is paired successfully with the second remote controller.

5. The method according to claim 1, wherein the method further comprises:
receiving a pairing disabling message transmitted by the first remote controller in the radio mode, wherein the pairing disabling message carries the first device identifier of the first remote controller; and
disabling pairing with the first remote controller according to the first device identifier.

6. The method according to claim 4, wherein after disabling pairing with the first remote controller, the method further comprises:
notifying a user that the first remote controller has been disabled from being paired.

7. The method according to claim 5, wherein after disabling pairing with the first remote controller, the method further comprises:
notifying a user that the first remote controller has been disabled from being paired.

8. A method for switching an operating mode of a remote controller, the method comprising:
if the remote controller operates in an infrared mode, then transmitting a pairing instruction to an electronic device upon detecting an event to trigger the remote controller to be switched to a radio mode, wherein the pairing instruction carries a device identifier of the remote controller; and
switching the remote controller to the radio mode after the remote controller is paired successfully with the electronic device.

9. The method according to claim 8, wherein the method further comprises:
if the remote controller operates in the radio mode, then transmitting a pairing disabling message carrying the device identifier of the remote controller to the electronic device upon detecting of an event to trigger pairing to be disabled.

10. An electronic device, comprising:
at least one processor; and
a memory communicably connected with the at least one processor for storing instructions executable by the at least one processor, wherein execution of the instructions by the at least one processor causes the at least one processor to:
receive a first pairing instruction transmitted by a first remote controller in an infrared mode, wherein the first pairing instruction carries a first device identifier of the first remote controller;
search a list of stored device identifiers to determine whether the first device identifier is present in the list; and
perform a pairing flow if the searching unit locates the first device identifier; and reject the first pairing instruction if the searching unit does not locate the first device identifier.

11. The electronic device according to claim 10, wherein the execution of the instructions by the at least one processor further causes the at least one processor to:
notify a user to perform pairing using a physical button on the remote controller after the pairing unit rejects the first pairing instruction.

12. The electronic device according to claim 10, wherein the execution of the instructions by the at least one processor further causes the at least one processor to:
receive a pairing key transmitted by the first remote controller;
verify the pairing key; and
determine that the paring is successful when the verification of the pairing key is passed;
and determine that the paring is unsuccessful when the verification of the pairing key is not passed.

13. The electronic device according to claim 12, wherein:
the execution of the instructions by the at least one processor further causes the at least one processor to receive a second pairing instruction transmitted by a second remote controller in the infrared mode, wherein the second pairing instruction carries a second device identifier of the second remote controller; and
the execution of the instructions by the at least one processor further causes the at least one processor to disable pairing with the first remote controller upon determining from the second device identifier that the electronic device is paired successfully with the second remote controller.

14. The electronic device according to claim 10, wherein:
the execution of the instructions by the at least one processor further causes the at least one processor to receive a pairing disabling message transmitted by the first remote controller in the radio mode, wherein the pairing disabling message carries the first device identifier of the first remote controller; and
the execution of the instructions by the at least one processor further causes the at least one processor to disable pairing with the first remote controller according to the first device identifier carried in the pairing disabling message.

15. The electronic device according to claim 13, wherein the execution of the instructions by the at least one processor further causes the at least one processor to:
notify a user that the first remote controller has been disabled from being paired, after the pairing unit disables pairing with the first remote controller.

16. The electronic device according to claim 14, wherein the execution of the instructions by the at least one processor further causes the at least one processor to:
notify a user that the first remote controller has been disabled from being paired, after the pairing unit disables pairing with the first remote controller.
